(19) United States
(12) Patent Application Publication
(10) Pub. No.: US 2008/0007515 A1
(43) Pub. Date: Jan. 10, 2008

(54) Liquid crystal display having a light sensor for adjusting luminance according to ambient light

(75) Inventors: Tian-Yi Wu, Shenzhen (CN); Ming-Bo Tai, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/825,865

(22) Filed: Jul. 9, 2007

(30) Foreign Application Priority Data
Jul. 7, 2006 (TW) 95124920

(51) Int. Cl. G09G 3/36

(52) U.S. Cl. 345/102

(57) ABSTRACT

An exemplary liquid crystal display (200) includes a liquid crystal panel (240), which includes a thin film transistor (TFT) substrate (245) having a display region (2451) and a non-display region (2452), a TFT array being formed at the display region; a light sensor (241) simultaneously formed on the TFT substrate with the TFT array, at the non-display region, for measuring a luminance of ambient light and generating a corresponding electrical signal according to ambient optical signal; a luminance control circuit (231) for receiving the electrical signal from the light sensor and transferring the optical signal to a measurement signal; and a backlight circuit (270) for driving a light source to emit light beams for illuminating the liquid crystal panel, according to the measurement signal from the luminance control circuit.

### FIELD OF THE INVENTION

The present invention relates to a liquid crystal display (LCD) for adjusting a luminance of a display screen of the active matrix LCD according to the ambient light.

### GENERAL BACKGROUND

An active matrix LCD device has the advantages of portability, low power consumption, and low radiation, and has been widely used in various portable information products such as notebooks, personal digital assistants (PDAs), video cameras and the like. Furthermore, the active matrix LCD device is considered by many to have the potential to completely replace CRT (cathode ray tube) monitors and televisions.

FIG. 6 is an abbreviated block diagram of certain parts of a typical active matrix LCD. The LCD 100 includes a liquid crystal (LC) panel 140, a gate driving circuit 130, a data driving circuit 120, and a timing control circuit 110, a power supply 150, and a backlight circuit 170. The backlight circuit 170 drives a light source to emit light beams for illuminating the LC panel 140. The timing control circuit 110 is used to control the gate driving circuit 130 and the data driving circuit 120. The gate driving circuit 130 provides a plurality of scanning signals to the LC panel 140. The data driving circuit 120 provides a plurality of gradation voltages to the LC panel 140 when the LC panel 140 is scanned.

However, the LCD 100 can not automatically adjust the brightness when the ambient brightness is changed. Thus a user may find that his or her eyes easily become tired.

What is needed, therefore, is an LCD that can overcome the above-described deficiency.

### SUMMARY

In one preferred embodiment, An exemplary liquid crystal display (200) includes a liquid crystal panel, including a thin film transistor (TFT) substrate having a display region and a non-display region, a TFT array being formed at the display region; a light sensor simultaneously formed on the TFT substrate with the TFT array, at the non-display region, for measuring a luminance of ambient light and generating a corresponding electrical signal according to ambient optical signal; a luminance control circuit for receiving the electrical signal from the light sensor and transferring the optical signal to a measurement signal; and a backlight circuit for driving a light source to emit light beams for illuminating the liquid crystal panel, according to the measurement signal from the luminance control circuit.

Other advantages and novel features will become more apparent from the following detailed description when taken in conjunction with the accompanying drawings.

### BRIEF DESCRIPTION OF THE DRAWINGS

FIG. 1 is an abbreviated block diagram of certain parts of an active matrix LCD according to a first embodiment of the present invention, the LCD including a thin film transistor (TFT) substrate.

FIG. 2 is a schematic, plane view of the TFT substrate, which includes a light sensor and a plurality of TFTs formed thereat.

FIG. 3 is a schematic, cross-sectional view showing a structure of the TFT substrate of FIG. 2 taken along a line of III-III.

FIG. 4 is an enlarged view of a part of the light sensor of FIG. 2.

FIG. 5 is a cross-sectional view of a part of the light sensor taken along a line of V-V.

FIG. 6 is a cross-sectional view showing a light sensor of an active matrix LCD according to a second embodiment of the present invention.

FIG. 7 is a plan view of an active matrix LCD according to a third embodiment of the present invention.

FIG. 8 is an abbreviated block diagram of certain parts of a conventional active matrix LCD.

### DETAILED DESCRIPTION OF PREFERRED EMBODIMENTS

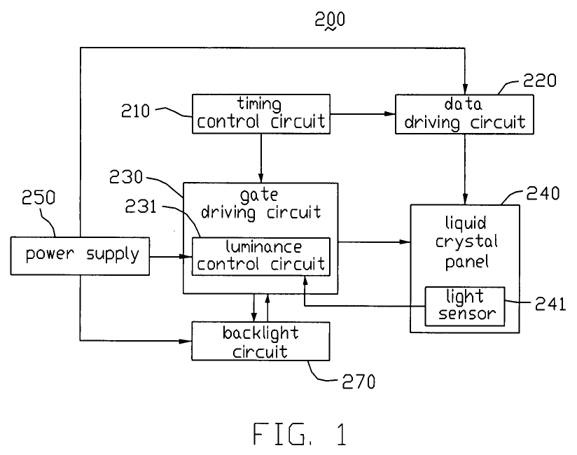

FIG. 1 is an abbreviated block diagram of certain parts of an active matrix LCD according to a first embodiment of the present invention. The active matrix LCD 200 includes a liquid crystal (LC) panel 240. The active matrix LCD 200 is configured such that an image shown on a display screen (not shown) of the LC panel 240 is refreshed. The active matrix LCD 200 also includes a timing control circuit 210, a power supply 250, a gate driving circuit 230 connected with the timing control circuit 210 and the power supply 250, a data driving circuit 220 connected with the timing control circuit 210 and the power supply 250, a luminance control circuit 231 integrated in the gate driving circuit 230, a light sensor 241, and a backlight circuit 270 connected with the power supply 250. The light sensor 241 is positioned on the LC panel 240 and is electrically coupled to the luminance control circuit 231. The luminance control circuit 231 controls the backlight circuit 270 and drives a light source (not shown) to emit light beams for illuminating the LC panel 240. The light source may be a light emitting diode (LED), or a cold cathode fluorescent lamp (CCFL).

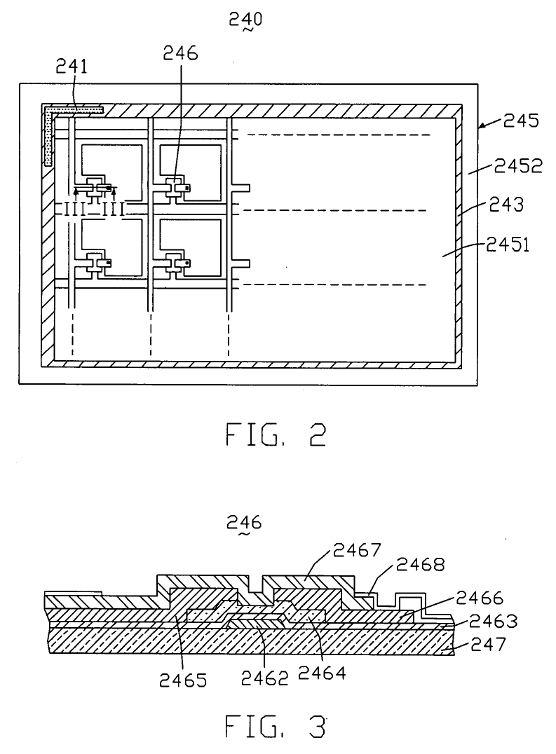

Referring also to FIG. 2, the LC panel 240 includes a thin film transistor (TFT) substrate 245 and a color filter substrate (not shown). The TFT substrate 245 includes a display region 2451 and a non-display region 2452 surrounding the display region 2451. The display region 2451 has a TFT array (not labeled) having a plurality of TFTs 246. The non-display region 2452 has a black matrix 243 disposed at a conterminous peripheral of the display region 2451 and the non-display region 2452, which the black matrix 243 is used to protect the light beams leakage. Under the black matrix 243, the light sensor 241 is provided on the TFT substrate 245, corresponding to an opening (not labeled) of the black matrix 243. Thus, the opening can assure the light beams irradiate the light sensor 241.

FIG. 3 is cross-sectional view of the TFT 246 taken along line III-III. The TFT 246 includes a gate electrode 2462 formed on a glass substrate 247, a gate insulating layer 2463 disposed on the gate electrode 2462 and the glass substrate 247, a semi-conducting layer 2464 formed on the gate insulating layer 2463, a source electrode 2465 and a drain electrode 2466 formed on the gate insulating layer 2463 and the semi-conducting layer 2464, an overcoat layer 2467 formed on the semi-conducting layer 2464, the source and drain electrodes 2465, 2466, and the gate insulating layer 2463, a pixel electrode 2468 formed on the overcoat layer 2467 and the drain electrode 2466. The semi-conducting layer 2464 includes an amorphous silicon layer (not shown) and a doped amorphous silicon layer (not shown).

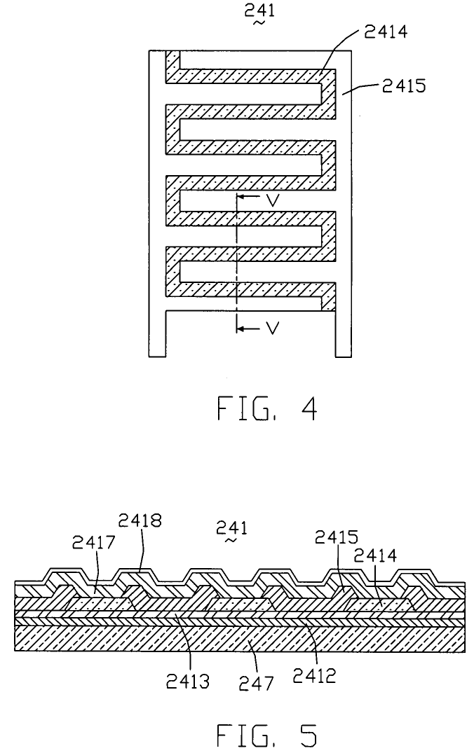

FIG. 4 and FIG. 5 respectively show a partially enlarged plan view and a partially enlarged cross-sectional view of the light sensor 246. The light sensor 246 has a metal layer 2412 formed on the glass substrate 247, an insulating layer 2413 formed on the metal layer 2412, a light sensor layer 2414 formed on the insulating layer 2413, being a square wave shape, an electrode structure 2415 formed on the insulating layer 2413 corresponding to the intervals of the light sensor layer 2414, a flatness layer 2417 formed on the light sensor layer 2414 and the electrode structure 2415, and a transparent conductive layer 2418 formed on the flatness layer 2417. The metal layer 2412 is formed with the gate electrode 2462 simultaneously, having a same material and being a same layer to the gate electrode 2462. The insulating layer 2413 is formed with the gate insulating layer 2463 simultaneously, having a same material and being a same layer to the gate insulating layer 2463. The light sensor layer 2414 is formed with the semi-conductive layer 2464 simultaneously, which is made from amorphous silicon. The electrode structure 2415 is formed with the source/drain electrodes 2465, 2466 simultaneously, having a same material and being a same layer to the source/drain electrodes 2465, 2466. The flatness layer 2417 is formed with the overcoat layer 2467 simultaneously, having a same material and being a same layer to the overcoat layer 2467. The transparent conductive layer 2418 is formed with the pixel electrode 2468 simultaneously, having a same material and being a same layer to the pixel electrode 2468.

The metal layer 2412 is used to shield the light beams. The light sensor layer 2414 is made from amorphous silicon material, which produces electron-hole pairs and electrically connects the electrode structure 2415 for transferring photo signals to electrical signals and sending the electrical signals to the luminance control circuit 231. In addition, the electrode structure 2415 is a comb-shaped for improving the sensitivity.

In operation, the light sensor 241 is simultaneously formed on the TFT substrate 246 with the TFT array, at the non-display region, for measuring a luminance of ambient light and generating a corresponding electrical signal according to ambient optical signal. The luminance control circuit 231 receives the electrical signal from the light sensor 241 and transferring the optical signal to a measurement signal. The backlight circuit 270 drives a light source (not shown) to emit light beams for illuminating the liquid crystal panel 240, according to the measurement signal from the luminance control circuit.

According to the configuration of the active matrix LCD 200, the light sensor 241 and the TFT array can be simultaneously formed at the non-display region and the display region, respectively. Comparing to the conventionally technology, the active matrix LCD 200 utilizes the light sensor 241 to detect the intensity of ambient light, and transfer the photo signals to the electrical signals, and send the electrical signals to the luminance control circuit 231. Thus, the active matrix LCD 200 can automatically adjust the luminance of a light source via the luminance control circuit 231 and the backlight circuit 270, according to the ambient light. This can help a user comfortably view the display screen of the LC panel 240 when the luminance of the ambient light changes. In addition, the light sensor 241 and the TFT array can be formed simultaneously on the display region and the non-display region of the TFT substrate 247, respectively. Thus, no additional manufacturing process is needed and the cost is economized.

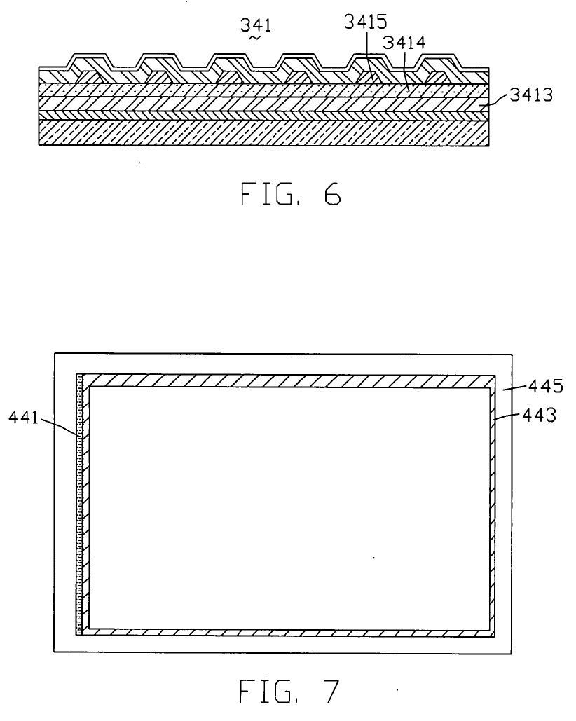

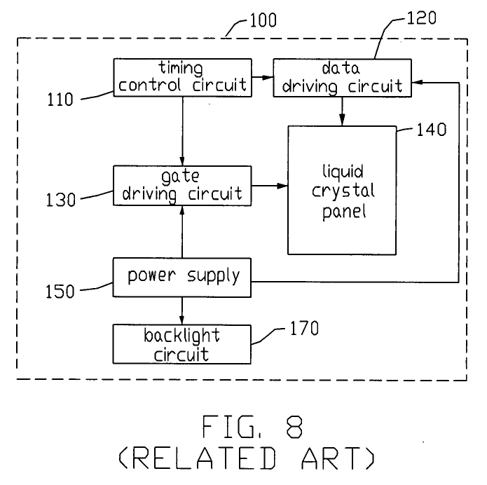

In addition, the configuration of the active matrix LCD of the present invention is not just limited as the above described. As shown in FIG. 6, a light sensor layer 3414 of a light sensor 341 can cover the whole surface of an insulating layer 3413. A comb-shaped electrode structure 3415 is provided on the light sensor layer 3414. This configuration of the light sensor 341 can also attain the similar effect. As shown in FIG. 7, a light sensor 441 can be disposed at the peripheral region of a black matrix 443 on the TFT substrate 445.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A liquid crystal display, comprising:
a liquid crystal panel, comprising a thin film transistor (TFT) substrate having a display region and a non-display region, a TFT array being formed at the display region;
a light sensor simultaneously formed on the TFT substrate with the TFT array, at the non-display region, for measuring a luminance of ambient light and generating a corresponding electrical signal according to ambient optical signal;
a luminance control circuit for receiving the electrical signal from the light sensor and transferring the optical signal to a measurement signal; and
a backlight circuit for driving a light source to emit light beams for illuminating the liquid crystal panel, according to the measurement signal from the luminance control circuit.

2. The liquid crystal display as claimed in claim 1, wherein the light sensor comprises a metal layer formed on a glass substrate of the TFT substrate, and the TFT comprises a gate electrode formed thereon, the metal layer being formed with the gate electrode simultaneously, having a same material and being a same layer to the gate electrode.

3. The liquid crystal display as claimed in claim 2, wherein the light sensor further comprises an insulating layer formed on the metal layer, and the TFT comprises a gate insulating layer formed on the gate electrode and the TFT substrate, the insulating layer being formed with the gate insulating layer simultaneously, having a same material and being a same layer to the gate insulating layer.

4. The liquid crystal display as claimed in claim 3, wherein the light sensor further comprises a light sensor layer formed on the insulating layer, and the TFT further comprises a semi-conductive layer formed on the gate insulating layer, the light sensor layer being formed with the semi-conductive layer simultaneously, which is formed of amorphous silicon.

5. The liquid crystal display as claimed in claim 4, wherein the light sensor layer is square wave shape.

6. The liquid crystal display as claimed in claim 5, wherein the light sensor further comprises an electrode structure formed on the insulating layer, corresponding to the intervals of the light sensor layer, and the TFT further comprises source/drain electrodes formed on the semi-conductive layer, the electrode structure being formed with the source/drain electrodes simultaneously, having a same material and being a same layer to the source/drain electrodes.

7. The liquid crystal display as claimed in claim 4, wherein the light sensor layer covers the whole surface of the insulating layer.

8. The liquid crystal display as claimed in claim 7, wherein the light sensor further comprises an electrode structure formed on the light sensor layer, being comb-shaped, and the TFT further comprises source/drain electrodes formed on the semi-conductive layer, the electrode structure being formed with the source/drain electrodes simultaneously, having a same material and being a same layer to the source/drain electrodes.

9. The liquid crystal display as claimed in claim 6, wherein the light sensor further comprises a flatness layer formed on the light sensor layer and the electrode structure, and the TFT further comprises an over coat layer formed on the semi-conducting layer, the source and drain electrodes and the gate insulating layer, the flatness layer being formed with the over coat layer simultaneously, having a same material and being a same layer to the over coat layer.

10. The liquid crystal display as claimed in claim 9, wherein the light sensor further comprises a transparent conductive layer formed on the flatness layer, and the TFT further comprises a pixel source/drain electrodes formed on the overcoat layer and the drain electrode, the transparent conductive layer being formed with the pixel electrode simultaneously, having a same material and being a same layer to the pixel electrode.

11. The liquid crystal display as claimed in claim 6, wherein the electrode structure electrically connects with the light sensor layer and the luminance control circuit.

12. The liquid crystal display as claimed in claim 8, wherein the electrode structure electrically connects with the light sensor layer and the luminance control circuit.

13. The liquid crystal display as claimed in claim 1, further comprising a black matrix being disposed at a conterminous peripheral of the display region and the non-display region.

14. The liquid crystal display as claimed in claim 13, wherein the light sensor is provided under the black matrix, corresponding an opening of the black matrix.

15. The liquid crystal display as claimed in claim 13, wherein the light sensor is disposed at the peripheral region of a black matrix on the TFT substrate.

16. A liquid crystal display, comprising: a liquid crystal panel having built-in light sensor which communicates with a luminance control circuit which is a part of a gate driving circuit activating said liquid crystal panel.
